(19) United States
(12) Patent Application Publication
(10) Pub. No.: US 2012/0069391 A1
(43) Pub. Date: Mar. 22, 2012

(54) Printing apparatus, printing system, and method of controlling printing apparatus

(75) Inventors: Hozumi Yonezawa, Tokyo (JP); Kohji Yamamoto, Kanagawa (JP); Masaaki Igarashi, Tokyo (JP); Takahiro Hirakawa, Kanagawa (JP)

(73) Assignee: Ricoh Company, Limited, Tokyo (JP)

(21) Appl. No.: 13/137,741

(22) Filed: Sep. 9, 2011

(30) Foreign Application Priority Data
Sep. 16, 2010 (JP) 2010-208300

(51) Int. Cl. G06F 3/12

(52) U.S. Cl. 358/1.15

(57) ABSTRACT

A printing apparatus that performs a printing process related to a print job including one print data item or a plurality of print data items and a series of process commands transmitted from a host apparatus and that is connected to another printing apparatus via a network, the printing apparatus including a status information acquiring unit that acquires status information of the printing apparatus when a status information transmission command is received as the process command transmitted from the host apparatus; a determining unit that synthetically determines whether the printing process can be continuously performed, on the basis of the status information of the printing apparatus and the status information of another printing apparatus connected to the printing apparatus via the network, when the status information of the printing apparatus acquired by the status information acquiring unit indicates an error; and a communication processing unit that transmits integrated status information corresponding to the determination result of the determining unit to the host apparatus.

### CROSS-REFERENCE TO RELATED APPLICATIONS

The present application claims priority to and incorporates by reference the entire contents of Japanese Patent Application No. 2010-208300 filed in Japan on Sep. 16, 2010.

### BACKGROUND OF THE INVENTION

1. Field of the Invention

The present invention relates to a printing apparatus, a printing system, and a method of controlling a printing apparatus.

2. Description of the Related Art

In recent years, an Internet printing system has been developed which performs printing via an Internet network. In addition, an extranet has been used in which the intranets of a plurality of companies or offices are connected to each other via the Internet network. According to this extranet, a host apparatus, such as a server, on one intranet can direct a printer on another intranet to perform a printing process (for example, Japanese Patent Application Laid-open No. 2009-301135).

However, when printing is stopped due to an error occurring in the main printer, the host apparatus needs to request both the main printer and the sub-printer to transmit their status information as a response in order to determine whether there is a sub-printer or whether the main printer can be replaced with the sub-printer. As a result, the interruption of the transmission of print data and reconnection to the Internet network frequently occur in the host apparatus. Therefore, a printing delay occurs and the reliability of printing is reduced.

### SUMMARY OF THE INVENTION

It is an object of the present invention to at least partially solve the problems in the conventional technology.

According to an aspect of the present invention, there is provided a printing apparatus that performs a printing process related to a print job including one print data item or a plurality of print data items and a series of process commands transmitted from a host apparatus and that is connected to another printing apparatus via a network, the printing apparatus including a status information acquiring unit that acquires status information of the printing apparatus when a status information transmission command is received as the process command transmitted from the host apparatus; a determining unit that synthetically determines whether the printing process can be continuously performed, on the basis of the status information of the printing apparatus and the status information of another printing apparatus connected to the printing apparatus via the network, when the status information of the printing apparatus acquired by the status information acquiring unit indicates an error; and a communication processing unit that transmits integrated status information corresponding to the determination result of the determining unit to the host apparatus.

According to another aspect of the present invention, there is provided a printing system including a host apparatus; and two or more printing apparatuses that perform a printing process related to a print job including one print data item or a plurality of print data items and a series of process commands transmitted from the host apparatus, wherein the host apparatus and the two or more printing apparatuses are connected via a network, and the printing apparatus comprises: a status information acquiring unit that acquires status information of the printing apparatus when a status information transmission command is received as the process command transmitted from the host apparatus; a determining unit that synthetically determines whether the printing process can be continuously performed, on the basis of the status information of the printing apparatus and the status information of another printing apparatus connected via the network, when the status information of the printing apparatus acquired by the status information acquiring unit indicates an error; and a communication processing unit that transmits integrated status information corresponding to the determination result of the determining unit to the host apparatus.

According to still another aspect of the present invention, there is provided a method of controlling a printing apparatus, the printing apparatus performing a printing process related to a print job including one print data item or a plurality of print data items and a series of process commands transmitted from a host apparatus and connected to another printing apparatus via a network, the method including acquiring status information of the printing apparatus when a status information transmission command is received as the process command transmitted from the host apparatus and storing the acquired status information in a storage unit; determining whether the printing process can be continuously performed, on the basis of the status information of the printing apparatus and the status information of another printing apparatus connected to the printing apparatus via the network, when the status information of the printing apparatus acquired in the acquiring of status information indicates an error; and transmitting the status information to the host apparatus according to the determination result in the determining.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram schematically illustrating an example of a structure of a net printing system according to a first embodiment;

FIG. 2 is a diagram schematically illustrating an example of a structure of the net printing system;

FIG. 3 is a block diagram illustrating an example of a structure of a printing server;

FIG. 4 is a block diagram illustrating an example of a structure of a printer;

FIG. 5 is a diagram schematically illustrating a functional structure related to a status information transmitting process of the printer;

FIG. 6 is a sequence diagram illustrating a procedure of a status information acquiring process of the net printing system;

FIG. 7 is a flowchart illustrating an outline of a printing process of a main printer shown in FIG. 5;

FIG. 8 is a flowchart illustrating a procedure of a control data processing shown in FIG. 7;

FIG. 9 is a sequence diagram illustrating a procedure of a status information acquiring process of a net printing system according to the related art;

FIG. 10 is a sequence diagram illustrating a procedure of another status information acquiring process of the net printing system;

FIG. 11 is a diagram schematically illustrating a functional structure related to a status information transmitting process of a printer according to a second embodiment;

FIG. 12 is a diagram illustrating an example of a customizing table shown in FIG. 11;

FIG. 13 is a sequence diagram illustrating a procedure of a status information acquiring process of a net printing system according to the second embodiment; and

FIG. 14 is a flowchart illustrating a procedure of control data processing according to the second embodiment.

### DETAILED DESCRIPTION OF THE PREFERRED EMBODIMENTS

Hereinafter, a printing system, a printing apparatus, a method of controlling a printing apparatus, a control program, and a storage medium storing a control program according to exemplary embodiments of the invention will be described in detail with reference to the accompanying drawings. However, the invention is not limited to the embodiments. In the drawings, the same components are denoted by the same reference numerals.

### First Embodiment

A first embodiment of the invention will be described below. In the first embodiment, a laser printer or a multi-function peripheral (MFP) is used as a printing apparatus.

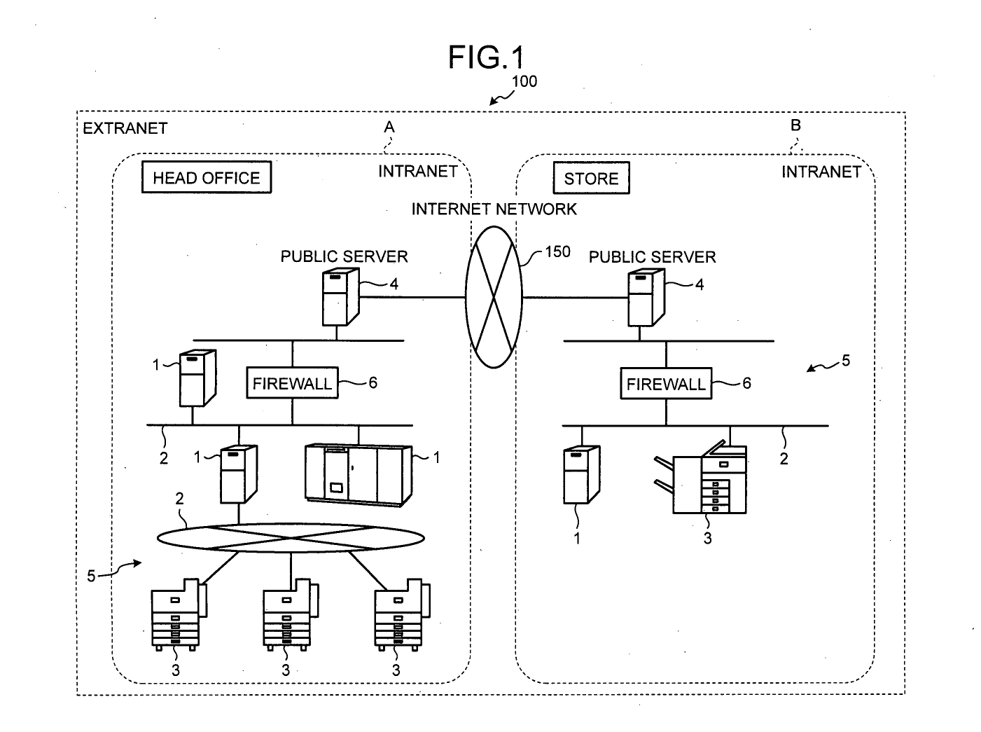

FIG. 1 is a diagram schematically illustrating an example of a structure of a net printing system 100 according to the first embodiment. As shown in FIG. 1, as the net printing system 100 according to the first embodiment, an extranet is considered in which intranets A and B of a plurality of companies or offices, which are company networks based on an Internet technique, are connected to each other by an Internet network 150.

As shown in FIG. 1, for example, as the intranet A of a convenience store head office, a server client system is considered in which a plurality of clients 3, such as computers or printers, is connected to various kinds of server computers (hereinafter, referred to as servers) 1 via a network 2, such as a local area network (LAN). In the intranet A, a firewall 6 is provided at the boundary between the Internet network 150 and a company network 5 except for a public server 4 such as a World Wide Web (WWW) server. The firewall 6 monitors packets transmitted between the company network 5 and the Internet network 150 and permits or blocks (discards) the transmission of the packets according to a predetermined rule, thereby ensuring the security of the company network 5.

In addition, for example, as the intranet B of a franchise store, a server client system is considered in which a plurality of clients 3, such as computers or printers, is connected to various kinds of servers 1 via the network 2, such as a LAN. In the intranet B, the firewall 6 is provided at the boundary between the Internet network 150 and the company network 5 except for the public server 4.

The network connecting the intranets A and B is not limited to the Internet network 150, but the intranets A and B may be connected to each other by a dedicated communication line.

The network 2 is not limited to wire communication, but it may be wireless communication (for example, infrared communication or radio communication). In addition, the network 2 may include optical fibers.

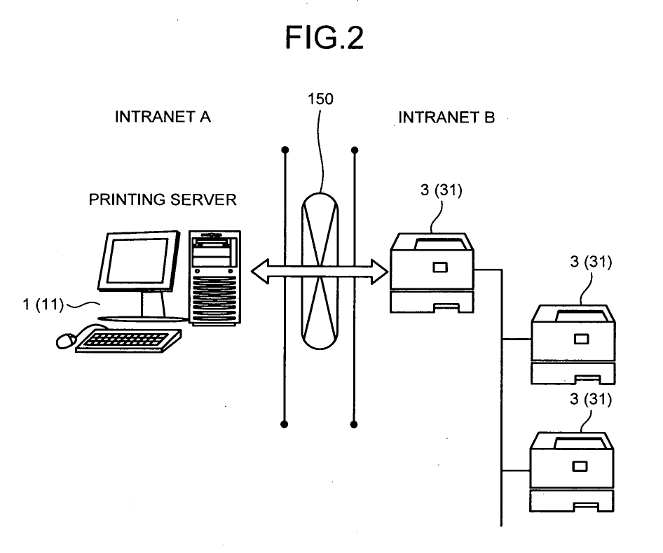

As shown in FIG. 2, for example, in the net printing system 100 as described above, a printing server 11, which is one of the servers 1 included in the intranet A of the convenience store head office directly performs a process of allowing a printer 31, which is one of the clients 3 included in the intranet B of the franchise store, to print sales promotion data. As shown in FIG. 2, the intranet B includes a plurality of printers 31 with the same function.

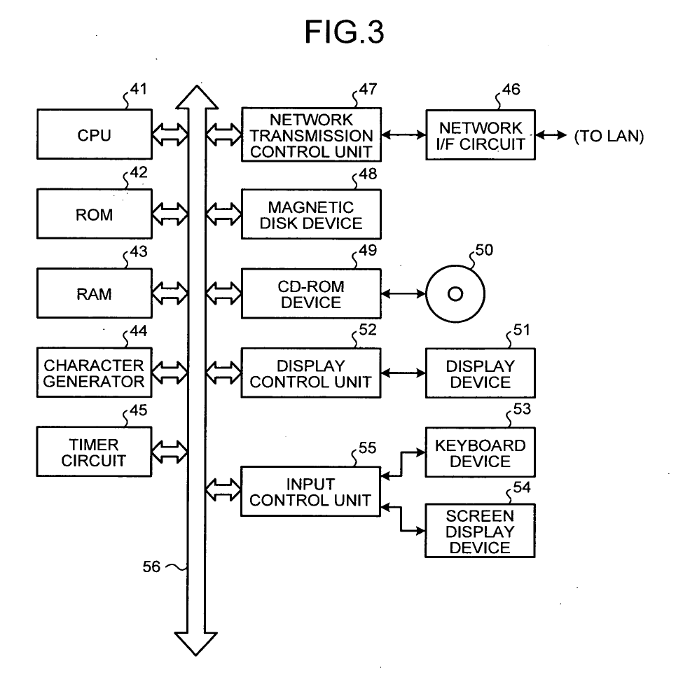

First, the printing server 11 (server 1) included in the intranet A will be described. FIG. 3 is a block diagram illustrating an example of a structure of the printing server 11. As shown in FIG. 3, the printing server 11 includes a central processing unit (CPU) 41 that controls the operation of the printing server 11. A read only memory (ROM) 42 for storing programs executed by the CPU 41 during startup or data required for startup and a random access memory (RAM) 43 for forming, for example, a work area of the CPU 41 are connected to the CPU 41 via an internal bus 56.

In addition, a character generator 44, a timer circuit 45, a network transmission control unit 47, a magnetic disk device 48, a compact disc read only memory device (CD-ROM device) 49, a display control unit 52, and an input control unit 55 are connected to the CPU 41 via the internal bus 56. Data is mainly transmitted between these components via the internal bus 56.

The character generator 44 is for generating display data of figures and characters. The timer circuit 45 is for outputting the current date and time information.

A network interface circuit 46 is for connecting the printing server 11 to the network 2 which is a LAN. The network transmission control unit 47 is for performing a communication control process of various kinds of predetermined protocol suites for transmitting various kinds of data between the printing server 11 and another server 1 or another client 3 via the network 2. For example, the network interface circuit 46 is connected to the printer 31, which is one of the clients 3 included in another intranet (in this embodiment, the intranet B) via the network 2 and the Internet network 150, and transmits print data to the printer 31 or receives the status of the printing process from the printer 31.

The magnetic disk device 48 is for storing an operating system (OS), various kinds of application programs running on the OS, and various kinds of data, such as work data, file data, and image information data. In this embodiment, for example, a print data transmission program is stored as the application program. The CD-ROM device 49 is for reading data (for example, various kinds of application programs and various kinds of data, such as work data, file data, and image information data) stored in a CD-ROM 50, which is a replaceable recording medium.

In the printing server 11, when the user turns on power, the CPU 41 starts a loader, which is a program in the ROM 42, and starts the OS by the RAM 43 reading the OS from the magnetic disk device 48. The OS starts application programs, reads information, or stores information in response to the operation of the user. The recording medium is not limited to the CD-ROM 50, but it may be a computer-readable recording medium, such as a flexible disk (FD), a compact disc recordable (CD-R), a compact disc-rewritable (CD-RW), a DVD, or a semiconductor memory. In this case, the CD-ROM device 49 may be changed to a device capable of reading data from the storage medium. The application program is not limited to the program running on a predetermined OS. For example, the application program may be a program that transfers the execution of some of the following various kinds of processes to the OS, or a program that is included as a portion of a group of program files forming predetermined application software or the OS.

In general, the application program installed in the magnetic disk device 48 of the printing server 11 is recorded on a storage medium, such as the CD-ROM 50, and the application program recorded on the storage medium is installed in the magnetic disk device 48. Therefore, a portable storage medium, such as the CD-ROM 50, may be a medium that stores the application program. In addition, the application program may be acquired from the outside via, for example, the network interface circuit 46 and then installed in the magnetic disk device 48.

A display device 51, such as a CRT, displays a screen for operating the printing server 11 and the display control unit 52 is for controlling the display content of the display device 51.

A keyboard device 53 is used by the user to input various kinds of instructions to the printing server 11 using various kinds of keys. A screen instruction device 54 (for example, a pointing device, such as a mouse) is for performing an operation of indicating an arbitrary point of the display device 51. The input control unit 55 is, for example, for acquiring information input from the keyboard device 53 and the screen instruction device 54.

The printing server 11 starts an appropriate application program and print document information is created by the application program, and then the print document information is stored in the magnetic disk device 48 of the printing server 11. Alternatively, the printing server 11 acquires print document information through the CD-ROM device 49 reading the print document information stored in the CD-ROM 50, and the acquired print document information is stored in the printing server 11. Alternatively, the print document information is reconstructed from information that is received through e-mail and so on via the network 2 and the Internet network 150, and the printing server 11 acquires the print document information, then the acquired print document information is stored in the printing server 11.

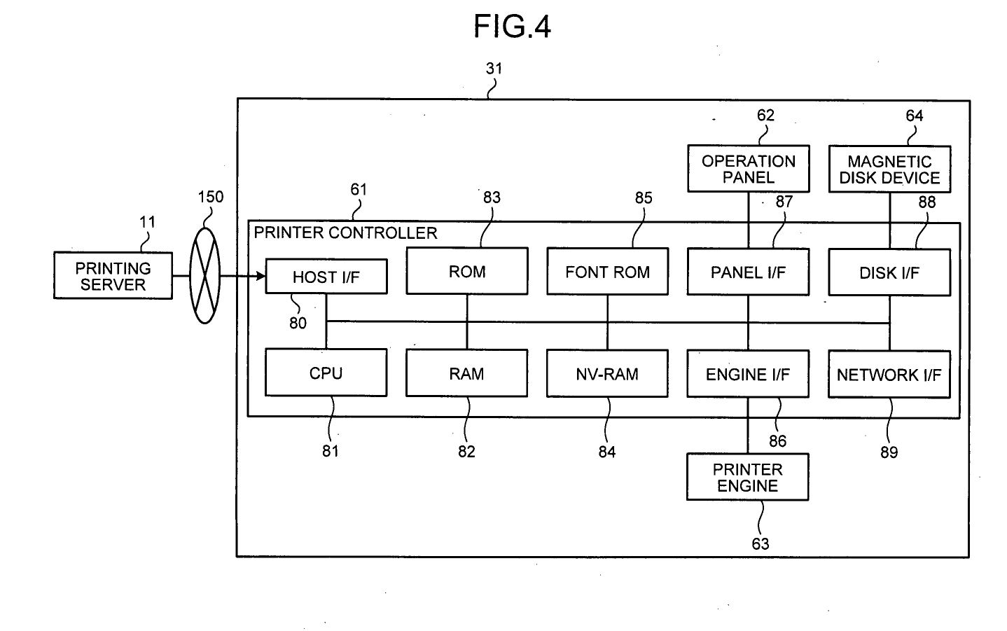

Next, the printer 31 (client 3), which is a printing apparatus included in the intranet B, will be described. The printer 31 (client 3) performs a printing process related to a print job including one print data item or a plurality of print data items and a series of process commands transmitted from a host apparatus. FIG. 4 is a block diagram illustrating an example of a structure of the printer 31. As shown in FIG. 4, the printer 31 includes a printer controller (mother board) 61 that performs various kinds of control processes, such as a process of controlling each unit of the printer 31 and an image forming process. The printer controller 61 is connected to an operation panel 62, a printer engine 63, and a magnetic disk device 64.

The printer controller 61 is a control mechanism that converts print data from various kinds of servers 1 (for example, the printing server 11 of the intranet A) in each of the intranets A and B into image data according to the control mode that is set at that time and control codes from various kinds of servers 1 (for example, the printing server 11 of the intranet A) in each of the intranets A and B and outputs the image data to the printer engine 63. The printer controller 61 includes the following modules. The printer controller 61 includes a host I/F 80 that receives control signals transmitted from various kinds of servers 1 in each of the intranets A and B to the printer 31 and transmits status information or data from the printer 31 to various kinds of servers 1, a CPU 81 which is a main control unit, a RAM 82, a ROM 83 that stores various kinds of information peculiar to the printer 31 including programs, a NV-RAM 84 which is a non-volatile memory capable of storing data regardless of whether power is turned on or, off, a Font ROM 85 which is a memory storing various kinds of fonts used for printing, an engine I/F 86, a panel I/F 87 that connects the operation panel 62, a disk I/F 88 that connects the magnetic disk device 64, and a network I/F 89.

The RAM 82 is used as a work area of the CPU 81, a buffer for receiving data from various kinds of servers 1 in each of the intranets A and B, and a processed image expansion region.

The engine I/F 86 transmits or receives control signals from the printer controller 61 to the printer engine 63 and status signals from the printer engine 63 to the printer controller 61.

The network I/F 89 receives the control signals and data transmitted from various kinds of servers 1 (for example, the printing server 11) in each of the intranets A and B to the printer 31 and transmits status signals from the printer 31 via the network 2.

The operation panel 62 is a switching unit capable of displaying the status of the printer 31 and changing the mode and printing conditions of the printer 31.

The printer engine 63 forms an image by using an electrophotography process, prints the image on a recording sheet, and outputs the recording sheet. Specifically, the printer engine 63 forms an electrostatic latent image on a photosensitive element, feeds a transfer sheet from a feed unit, and forms an image on the transfer sheet, on the basis of image data and control information from the printer controller 61.

The magnetic disk device 64 stores, for example, various kinds of print document information or appropriate information files other than the print document information. In addition, the magnetic disk device 64 stores various kinds of application programs running on the operating system (OS). In this embodiment, for example, a printing process program is stored as an application program.

Similar to the server 1, the printer 31 having the above-mentioned structure, when the user turns on power, starts the OS by the RAM 82 reading the OS from the magnetic disk device 64. The OS that starts in this way starts application programs, reads information, or stores information in response to the operation of the user. The application program is not limited to the program running on a predetermined OS. For example, the application program may be a program that transfers the execution of some of the following various kinds of processes to the OS, or a program that is included as a portion of a group of program files forming predetermined application software or the OS.

In general, the application program installed in the magnetic disk device 64 of the printer 31 is recorded on a storage medium, such as a CD-ROM (not shown), and the application program recorded on the storage medium is installed in the magnetic disk device 64. Therefore, a portable storage medium, such as the CD-ROM, may be a medium that stores the application program. In addition, the application program may be acquired from the outside via, for example, the network I/F 89 and then installed in the magnetic disk device 64.

In this embodiment, the printer 31 includes the magnetic disk device 64, but the invention is not limited thereto. For example, the application programs or the OS may be stored in a computer readable recording medium, such as a semiconductor memory.

In the net printing system 100, before outputting print data to the printer 31 of the intranet B via the Internet network 150, the printing server 11 of the intranet A serving as a host apparatus of the net printing system 100 requests the printer 31 of the intranet B, which is an output destination, to transmit status information as a response, thereby acquiring the printer 31 that prints print data, on the basis of the status information transmitted from the printer 31.

In the net printing system 100 according to this embodiment, in the intranet B which is the output destination of print data, even when an error (printing unavailable state) has occurred in the main printer among the printers 31, the status information of the other printers 31 in the intranet B, which is an output destination is acquired, and integrated status information is transmitted to the printing server 11. Specifically, even when an error has occurred in the main printer, if the status information transmitted from the other printers 31 includes status information indicating that there is no error, then the intranet B, which is an output destination, transmits status information indicating that printing can be continuously performed with another printer 31 without an error, to the printing server 11 of the intranet A. Accordingly, printing can be continuously performed in the intranet B, such that printing is not stopped in the intranet B.

Next, among various kinds of processes of the printing server 11 and the printer 31, the process of the printer 31 of the intranet B transmitting status information in a response to a status information response request transmitted from the printing server 11 of the intranet A will be described.

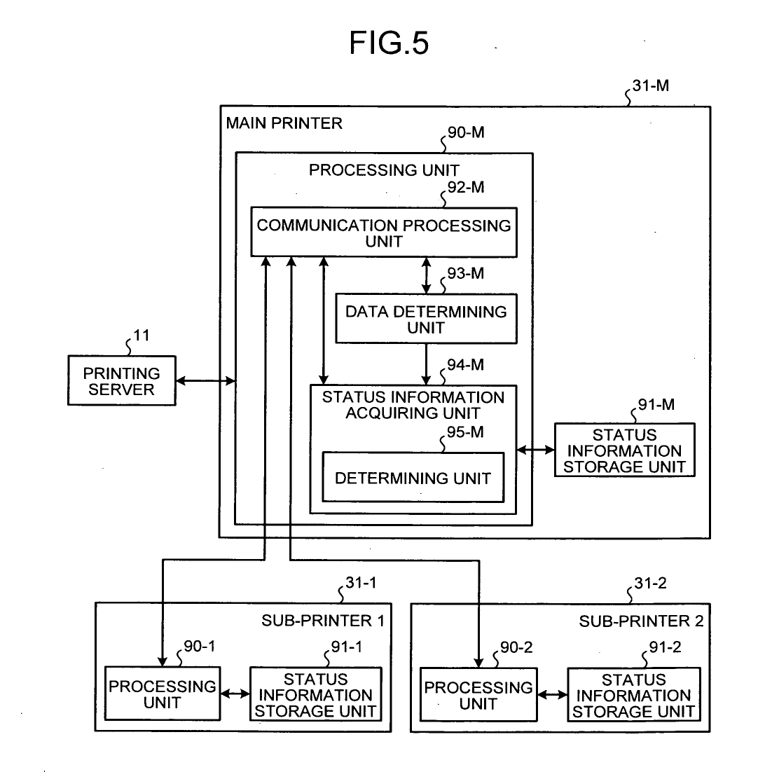

FIG. 5 is a diagram schematically illustrating a functional structure related to a process of the printer 31 transmitting the status information. In FIG. 5, the intranet B is considered in which three printers 31, that is, a printer 31-M, which is a “main printer”, a printer 31-1, which is a “sub-printer 1”, and a printer 31-2, which is a “sub-printer 2”, are connected to the network. The “main printer”, the “sub-printer 1”, and the “sub-printer 2” are set for convenience of explanation, and the printer 31-M, the printer 31-1, and the printer 31-2 have the same structure. The printer 31-M to which print data is input first from the printing server 11 of the intranet A, which is a host apparatus, via the network is referred to as the main printer and the printers 31-1 and 31-2 that are disposed below the main printer are referred to as sub-printers.

The “main printer” is uniquely determined by the host apparatus. The “sub-printer 1” and the “sub-printer 2” may be fixedly determined and the order thereof may be changed in each process. For example, the order of the “sub-printer 1” and the “sub-printer 2” may be set by storing the IP address of the printer that will transmit data in the next stage in the storage unit (for example, the ROM 83, the NV-RAM 84, or the magnetic disk device 64) of the printer and referring to the stored IP address during the transmission of data.

As shown in FIG. 5, the printer 31-M includes a processing unit 90-M that transmits or receives data via the network, and a status information storage unit 91-M that stores status information which is opened to the public in order to notify the status of a network apparatus to the outside. The processing unit 90-M includes a communication processing unit 92-M, a data determining unit 93-M, and a status information acquiring unit 94-M.

When the connection between the printer 31-M, and the printing server 11 and the other printers 31 via the network is established, the communication processing unit 92-M performs a process of controlling the transmission or reception of data via the network. The data received by the communication processing unit 92-M is transmitted to the data determining unit 93-M.

The data determining unit 93-M determines whether the data is control data including a control command. When it is determined that the data is predetermined control data, the data determining unit 93-M analyzes the control command in the control data. When the control command is a status information transmission command, the data determining unit 93-M outputs the status information transmission command to the status information acquiring unit 94-M.

The status information acquiring unit 94-M acquires the status information of the main printer from the status information storage unit 91-M. The status information acquiring unit 94-M includes a determining unit 95-M that instructs the communication processing unit 92-M to output the status information transmission command to the sub-printers 1 and 2 (printers 31-1 and 31-2) in the intranet B connected thereto via the network when the acquired status information of the main printer indicates that there is an error. The determining unit 95-M synthetically determines whether the printing process can be continuously performed on the basis of the status information of the main printer and the status information transmitted from the sub-printers 1 and 2 and creates integrated status information according to the determination result. The communication processing unit 92-M transmits the integrated status information created by the determining unit 95-M to the printing server 11.

Similarly to the printer 31-M, which is the main printer, the printers 31-1 and 31-2, which are the sub-printers 1 and 2, include processing units 90-1 and 90-2 and status information storage units 91-1 and 91-2, respectively.

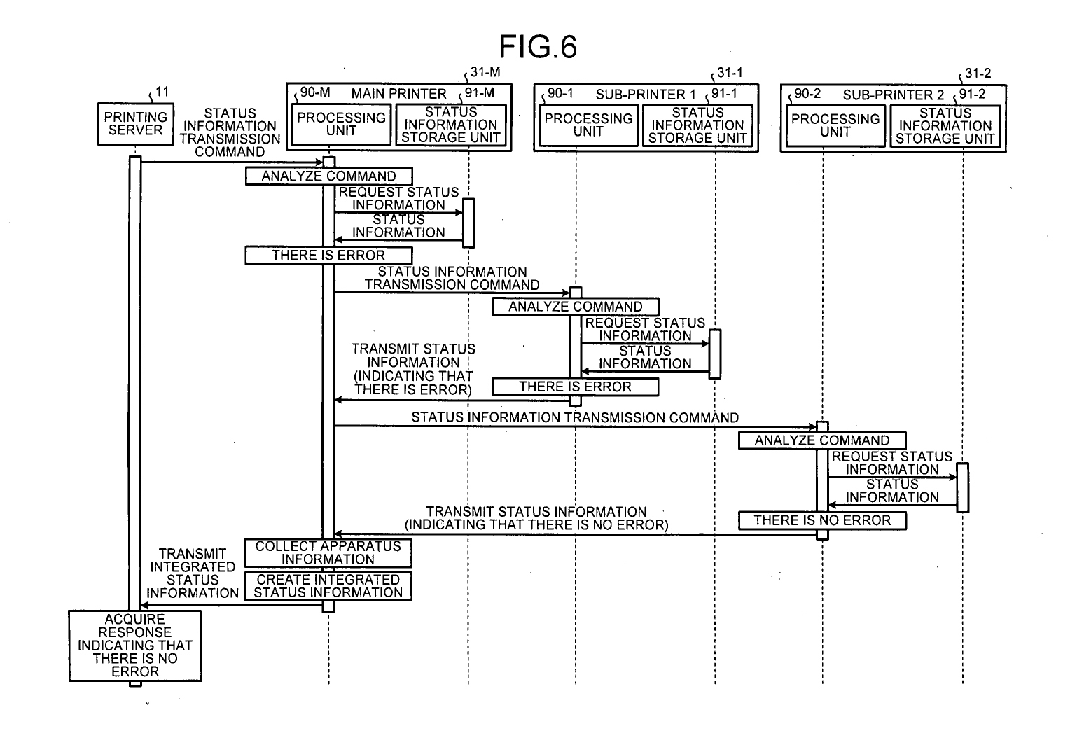

Next, the operation of acquiring the status information will be described with reference to the sequence diagram shown in FIG. 6. When the printer 31-M, which is the main printer, receives a control data including a status information transmission command from the printing server 11, which is a host apparatus, the processing unit 90-M analyzes the command. When the status information transmission command is included, the processing unit 90-M requests the status information storage unit 91-M to transmit the status information of the main printer and acquires the status information.

When the acquired status information of the main printer indicates that there is an error and there is the subordinate printer 31-1 (sub-printer 1), the processing unit 90-M outputs a status information transmission command to the subordinate printer 31-1. When the acquired status information of the printer 31-M indicates that there is no error, the processing unit 90-M transmits the status information indicating that there is no error to the printing server 11 without any change.

In the subordinate printer 31-1 (sub-printer 1) receiving the status information transmission command, the processing unit 90-1 analyzes the command, requests the status information storage unit 91-1 to transmit the status information in response to the status information transmission command, acquires the status information of the sub-printer 1, and outputs the acquired status information (for example, the status information indicating that there is an error) to the printer 31-M (main printer).

In addition, when there is the subordinate printer 31-2 (sub-printer 2), a status information transmission command is output to the printer 31-2 from the printer 31-M (main printer). In the printer 31-2 (sub-printer 2) receiving the status information transmission command, the processing unit 90-2 analyzes the command, acquires the status information of the sub-printer 2 from the status information storage unit 91-2 in response to the status information transmission command, and outputs the acquired status information (for example, the status information indicating that there is no error) to the printer 31-M (main printer).

The printer 31-M (main printer) collects the status information transmitted from the printers 31-1 and 31-2 (sub-printers 1 and 2). In the example shown in FIG. 6, since no error occurs in the printer 31-2 (sub-printer 2), the printer 31-M (main printer) creates the integrated status information indicating that it is possible to continuously perform printing with the printer 31-2 (sub-printer 2) and transmits the integrated status information to the printing server 11. The printing server 11 acquires the integrated status information indicating that no error occurs in the printer 31-2 (sub-printer 2) and transmits print data to the printer 31-2 (sub-printer 2) in the intranet B such that the printer 31-2 (sub-printer 2) continuously performs the printing process.

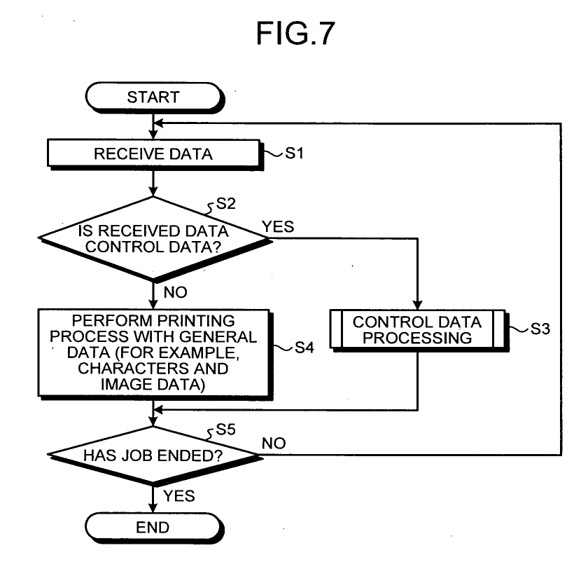

FIG. 7 is a flowchart illustrating an outline of the printing process of the printer 31-M (main printer). As shown in FIG. 7, when the printing server 11, which is a host apparatus, starts to transmit data, the communication processing unit 92-M of the printer 31-M (main printer) receives the data (Step S1) and the data determining unit 93-M analyzes the data and determines whether the data is control data including a control command (Step S2).

When the data determining unit 93-M determines that the received data is control data including a control command (Yes in Step S2), each component of the printer 31-M (main printer) performs a process (control data processing) corresponding to the control command included in the control data (Step S3).

On the other hand, when the data determining unit 93-M determines that the received data is not control data including a control command (No in Step S2), each component of the printer 31-M (main printer) performs a printing process (general data processing) with general data (Step S4). The general data is, conceptually, data of a printing target and is, for example, character data or image data.

After Step S3 or Step S4 ends, the printer 31-M (main printer) determines whether the job has ended (Step S5). When the printer 31-M (main printer) determines that the job has ended (Yes in Step S5), one print job ends. When the printer 31-M (main printer) determines that the job has not ended (No in Step S5), the process returns to Step S1 and Steps S1 to S4 are performed. Steps S1 to S4 are repeatedly performed until it is determined that the job had ended (Yes in Step S5).

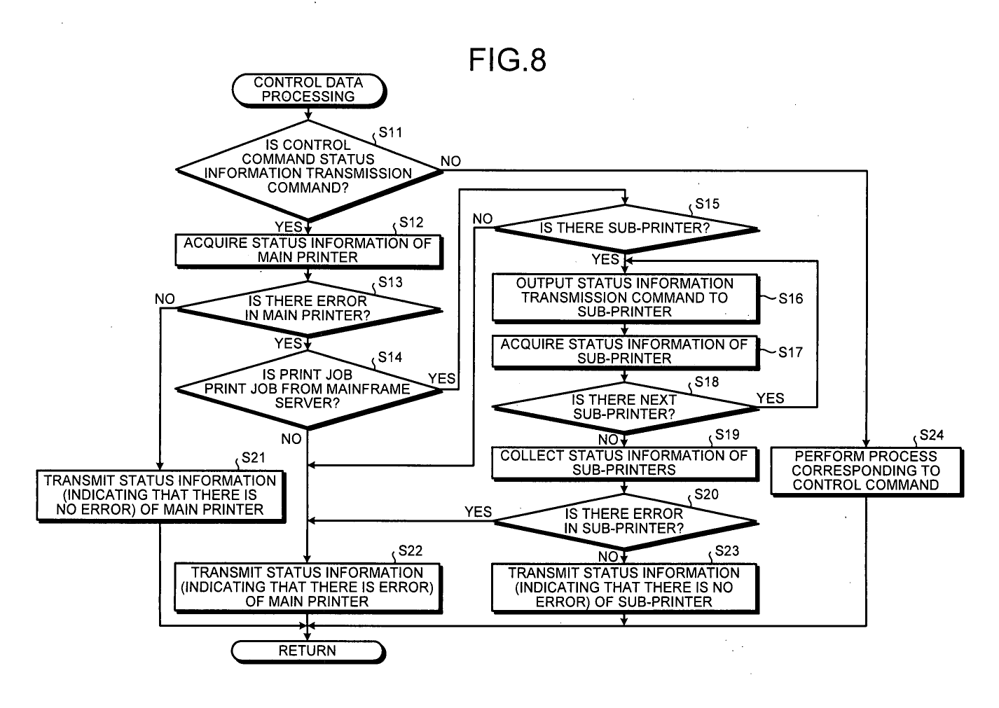

FIG. 8 is a flowchart illustrating a procedure of the control data processing shown in FIG. 7. As shown in the flowchart of FIG. 8, when the data to be processed is the control data, the data determining unit 93-M of the printer 31-M (main printer) determines whether the control command included in the control data is a status information transmission command (Step S11).

When the data determining unit 93-M determines that the control command is not a status information transmission command (No in Step S11), each component of the printer 31-M (main printer) performs a process corresponding to the control command (Step S24) and ends the control data processing.

On the other hand, when the data determining unit 93-M determines that the control command is a status information transmission command (Yes in Step S11), the status information acquiring unit 94-M acquires the status information of the printer 31-M (main printer) (Step S12). The determining unit 95-M determines whether an error occurs in the main printer on the basis of the acquired status information (Step S13).

When it is determined that no error occurs in the main printer (No in Step S13), the determining unit 95-M directs the communication processing unit 92-M to transmit the status information (status information indicating that there is no error) of the main printer to the printing server 11 (Step S21) since printing can be continuously performed. Then, the control data processing ends.

On the other hand, when the determining unit 95-M determines that an error occurs in the main printer (Yes in Step S13), the data determining unit 93-M determines whether the print job is a print job from the mainframe server, such as business form printing (Step S14).

When the data determining unit 93-M determines that the print job is not a print job from the mainframe server (No in Step S14), the determining unit 95-M directs the communication processing unit 92-M to transmit the status information (status information indicating that there is an error) of the main printer to the printing server 11 since the priority level of the continuation of printing is low (Step S22). Then, the control data processing ends.

On the other hand, when the data determining unit 93-M determines that the print job is a print job from the mainframe server (Yes in Step S14), the determining unit 95-M determines whether there is a sub-printer connected to the main printer via the network in order to determine whether printing can be continuously performed with the sub-printer since the priority level of the continuation of printing is high (Step S15).

When it is determined that there is no sub-printer connected to the main printer via the network (No in Step S15), the determining unit 95-M directs the communication processing unit 92-M to transmit the status information (status information indicating that there is an error) of the main printer to the printing server 11 since a substitute printing process can not be performed (Step S22). The, the control data processing ends.

On the other hand, when it is determined that there is a sub-printer connected to the main printer via the network (Yes in Step S15), the determining unit 95-M directs the communication processing unit 92-M to output a status information transmission command to the sub-printer since it is possible to perform the printing process with the sub-printer (Step S16) and acquires the status information of the sub-printer (Step S17).

The determining unit 95-M determines whether there is a next sub-printer connected to the main printer via the network (Step S18). When the determining unit 95-M determines that there is a next sub-printer (Yes in Step S18), the process returns to Step S16 and the determining unit 95-M directs the communication processing unit 92-M to output a status information transmission command to the sub-printer and acquires the status information of the sub-printer (Step S17).

When it is determined that there is no next sub-printer (No in Step S18), the determining unit 95-M collects the acquired status information of each sub-printer (Step S19) and determines whether an error occurs in the sub-printers (Step S20). When it is determined that an error occurs in all of the sub-printers (Yes in Step S20), the determining unit 95-M directs the communication processing unit 92-M to transmit the status information (status information indicating that there is an error) of the main printer to the printing server 11 (Step S22). Then, the control data processing ends.

On the other hand, when it is determined that an error does not occur in any of the sub-printers (No in Step S20), the determining unit 95-M directs the communication processing unit 92-M to transmit the status information (indicating that there is no error) of the sub-printer as the integrated status information to the printing server 11 (Step S23). Then, the control data processing ends.

In this way, the printing server 11 of the intranet A that acquires the status information (status information indicating that there is no error) of the sub-printer(s) of the intranet B transmits the print job from the mainframe server in the intranet B to the sub-printer with the status information indicating that there is no error and directs the sub-printer to print the print job from the mainframe server.

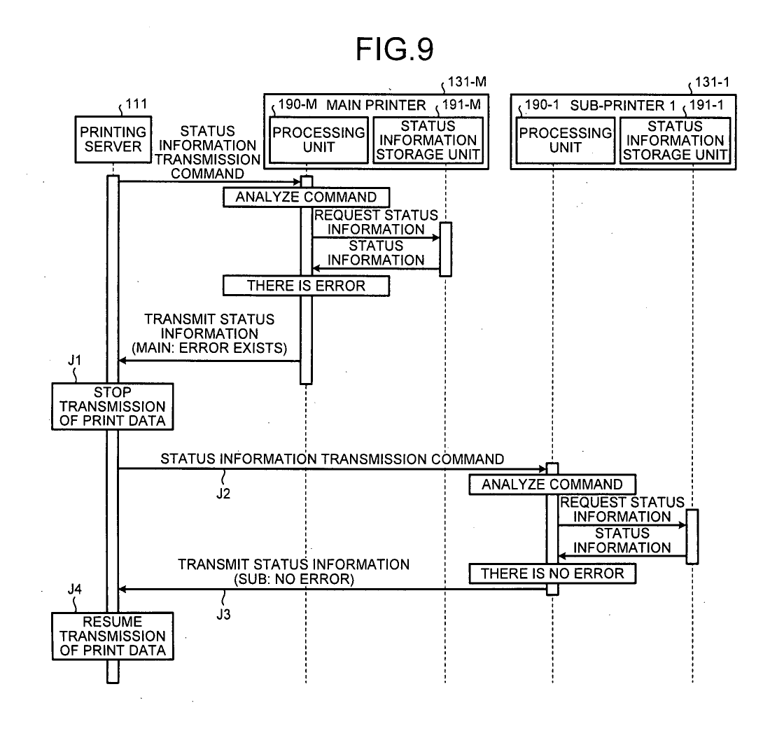

In the related art, as shown in the sequence diagram of FIG. 9, when a printer 131-M, which is a main printer, receives control data including a status information transmission command from a printing server 111, which is a host apparatus, a processing unit 190-M analyzes the command and transmits the status information (status information indicating that there is an error) of the main printer acquired from a status information storage unit 191-M to the printing server 111. The printing server 111 acquiring the status information (status information indicating that there is an error) of the main printer performs a process (J1) of stopping the transmission of print data and then performs a process (J2) of transmitting a control data including a status information transmission command to a printer 131-1, which is a sub-printer 1, in order to know whether there is a sub-printer or whether the main printer is replaceable with the sub-printer. In this case, the printing server 111 waits until the status information (status information indicating that there is no error) of the printer 131-1 acquired from a status information storage unit 191-1 is transmitted from a processing unit 190-1. Then, the printing server 111 performs a process (J3) of receiving the status information (indicating that there is no error) of the printer 131-1 and then performs a process (J4) of resuming the transmission of the print data.

As such, in the related art, when there is an error in the main printer of the intranet, which is the output destination of print data, the host apparatus checks whether there is a sub-printer or whether the main printer can be replaced with a sub-printer. Therefore, the interruption of the transmission of the print data and reconnection to the Internet network are intermittently performed by the host apparatus. As a result, a printing delay occurs and the reliability of printing is reduced.

In contrast, in the first embodiment, even when there is an error in the main printer of the intranet, which is the output destination of print data, the main printer, not the host apparatus, acquires the status information of the sub-printer and transmits, to the host apparatus, the integrated status information indicating that printing can be continuously performed with another printer 31 without an error. As a result, in the first embodiment, when it is determined whether there is a sub-printer or whether the main printer can be replaced with the sub-printer, the interruption of the transmission of the print data and reconnection to the Internet network do not occur in the host apparatus. Therefore, in this embodiment, it is possible to reduce a printing delay and thus improve the reliability of printing. In addition, in the case of a print job from the mainframe server, the main printer increases the priority level of the continuation of printing and checks whether there is a sub-printer or whether the main printer can be replaced with the sub-printer. Therefore, it is possible to improve the throughput of the print job from the mainframe server.

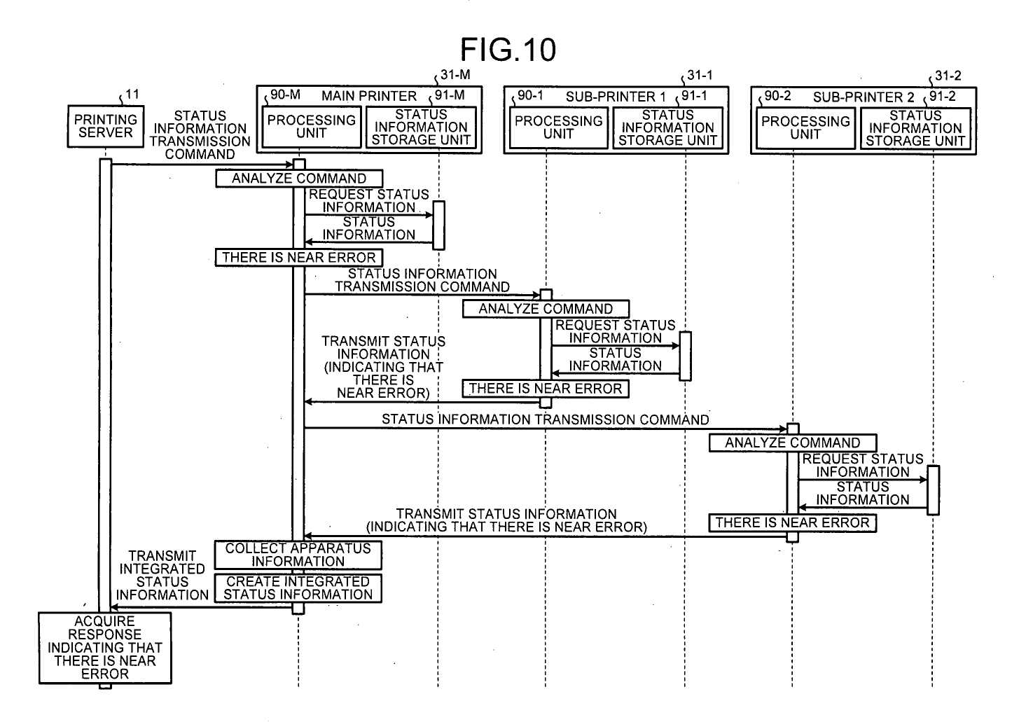

The result of this embodiment is not limited to that shown in the sequence diagram of FIG. 6, but a status information acquiring operation shown in a sequence diagram of FIG. 10 may be performed. As shown in FIG. 10, when the printer 31-M, which is the main printer, receives a control data including a status information transmission command from the printing server 11, which is a host apparatus, the processing unit 90-M analyzes the command and acquires the status information of the main printer from the status information storage unit 91-M. When the status information of the main printer indicates a near error (print job overlap state) among the errors, the processing unit 90-M outputs a status information transmission command to the printer 31-1 which is a sub-printer.

The processing unit 90-M of the main printer acquires status information (status information indicating there is a near error) from the printer 31-1 (sub-printer 1) receiving the status information transmission command. Then, the processing unit 90-M of the main printer also outputs a status information transmission command to different printer 31-2 (sub-printer 2) and acquires status information (status information indicating that there is a near error) from the printer 31-2 receiving the status information transmission command.

The printer 31-M (main printer) collects the status, information transmitted from the printers 31-1 and 31-2 (sub-printers 1 and 2). When a near error occurs in both the sub-printers 1 and 2, the printer 31-M creates the integrated status information (status information indicating that there is a near error) indicating that it is possible to continuously perform printing by adjusting the execution timing of the printing process and transmits the integrated status information to the printing server 11. The printing server 11 acquires the status information indicating that there is a near error, adjusts (for example, delays) the execution timing of the printing process of the intranet B, and transmits print data such that any one of the main printer and the sub-printers 1 and 2 continuously performs the printing process. In this case, it is possible to continuously perform printing and thus improve the reliability of printing. In addition, the status information which is created by the printer 31-M (main printer) on the basis of the status information of the sub-printers 1 and 2 and the status information of the main printer is set in advance according to a combination of the content of the status information of each printer.

### Second Embodiment

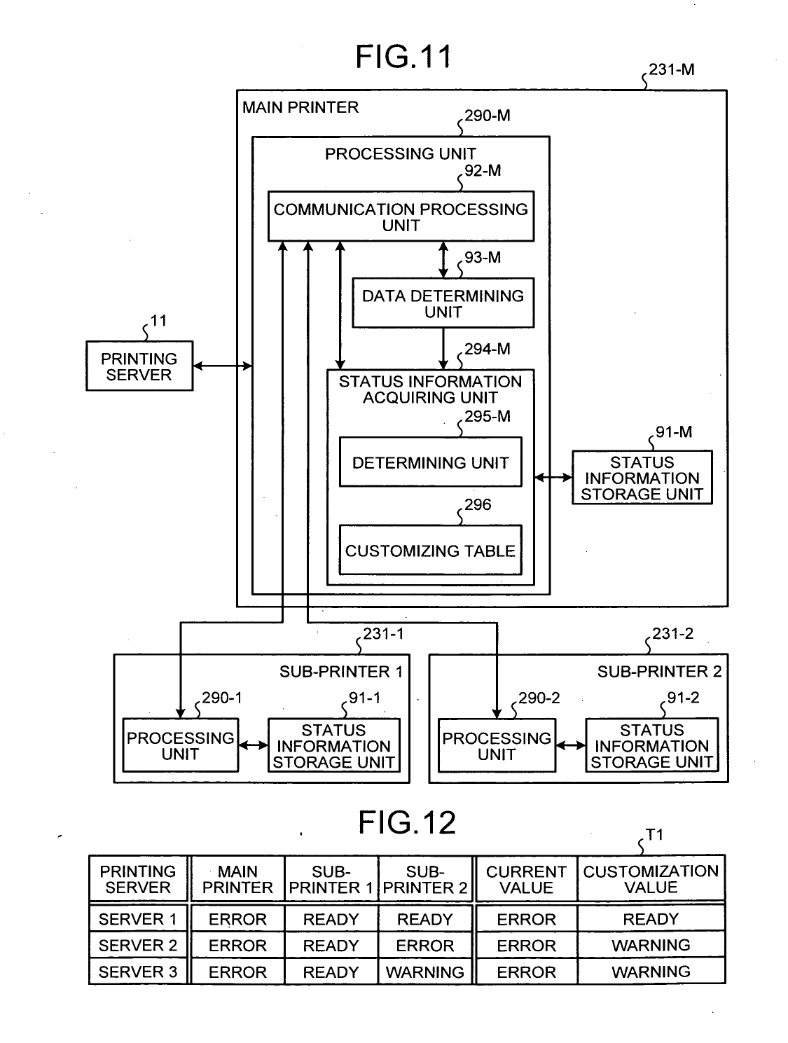

Next, a second embodiment will be described. In the second embodiment, a case in which the status information that is transmitted from the main printer and that is indicating whether printing can be continuously performed is customized for each printing apparatus will be described. FIG. 11 is a diagram schematically illustrating a functional structure related to a status information transmitting process of a printer according to the second embodiment.

As shown in FIG. 11, a printer 31-M (main printer) according to the second embodiment includes a processing unit 290-M instead of the processing unit 90-M shown in FIG. 5. The processing unit 290-M includes a status information acquiring unit 294-M including a determining unit 295-M and a customizing table 296, instead of the status information acquiring unit 94-M shown in FIG. 5.

The customizing table 296 is uniquely set to a printer 231-M (main printer) and printers 231-1 and 231-2 (sub-printers) in an intranet B, which is the output destination of print data. The customizing table 296 associate with status information to be transmitted to a printing server 11, which is a host apparatus, according to a combination of the status information of the printer 231-M and the status information of the printers 231-1 and 231-2 in advance. The customizing table 296 is stored in the NV-RAM 84, which is a non-volatile memory.

For example, the integrated status information to be transmitted to the printing server 11, which is a host apparatus, according to the combination of the status information of the printer 231-M (main printer) and the status information of the printers 231-1 and 231-2 (sub-printers 1 and 2) is set in the customizing table 296 in advance so as not to hinder the operation of the printing server 11, according to the purpose of a print job from the mainframe server. For example, as shown in a table T1 of FIG. 12, in the customizing table 296, integrated status information items are associated with each other in which, even when the status information of the printer 231-M and the status information of the printers 231-1 and 231-2 are combined such that the current values of the printers are all errors, printing can be continuously performed (ready) or a warning (printing is possible, but there is a problem: warning) is given. The customizing table 296 is set such that printing can be continuously performed as much as possible. When there is a plurality of printing servers 11, which are host apparatuses of the printers 231-M, 231-1, and 231-2 (FIG. 12 shows three printing servers 11, that is, servers 1 to 3), the content of the integrated status information to be customized may be set in the customizing table 296 so as to correspond to the processing performances of each printing server 11.

When there is an error in the main printer, the determining unit 295-M selects the integrated status information corresponding to a combination of the status information of the main printer acquired by a status information determining unit 294 and the status information of the sub-printers 1 and 2 from the integrated status information items in the customizing table 296 and directs a communication processing unit 92-M to transmit the selected integrated status information to the printing server 11. Similarly to the printer 231-M, which is the main printer, the printers 231-1 and 231-2, which are the sub-printers 1 and 2, include processing units 290-1 and 290-2, instead of the processing units 90-1 and 90-2.

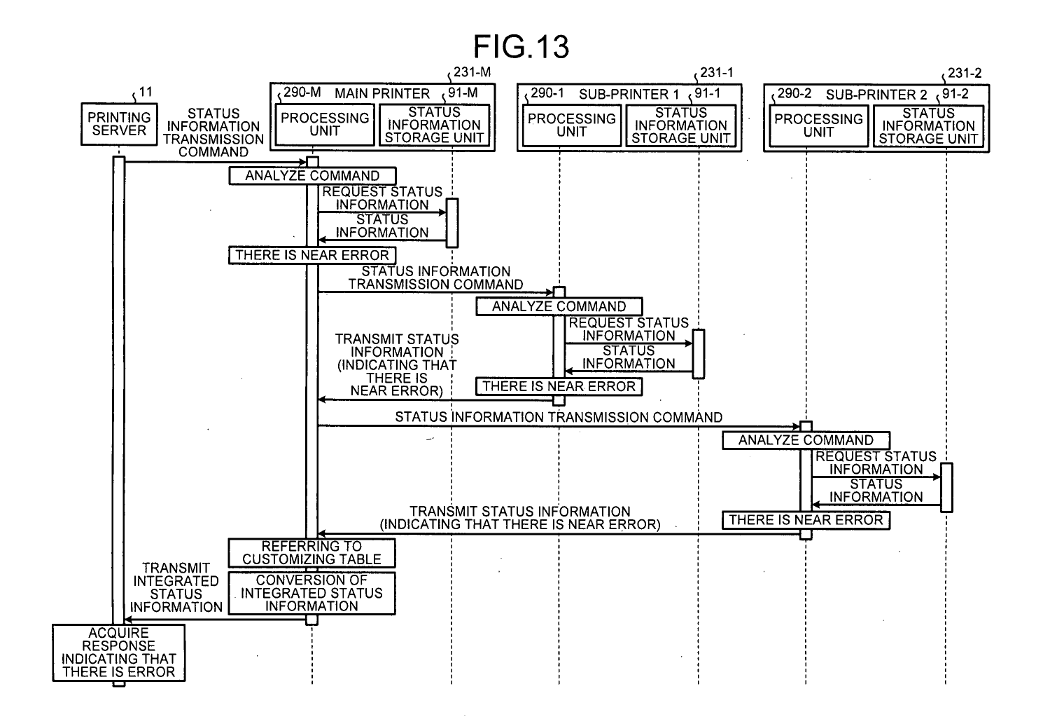

Next, a status information acquiring operation according to the second embodiment will be described with reference to a sequence diagram shown in FIG. 13. As shown in FIG. 13, when the printer 231-M, which is the main printer, receives control data including a status information transmission command transmitted from the printing server 11, which is a host apparatus, the processing unit 290-M analyzes the command and acquires the status information of the printer 231-M from the status information storage unit 91-M. When the error indicated by the status information of the main printer is a near error, the processing unit 290-M outputs a status information transmission command to the printer 231-1, which is a sub-printer.

The processing unit 290-M of the main printer acquires status information (status information indicating that there is a near error) from the printer 231-1 (sub-printer 1) receiving the status information transmission command. Then, the processing unit 290-M of the main printer also outputs a status information transmission command to different printer 231-2 (sub-printer 2) and acquires status information (status information indicating that there is a near error) from the printer 231-2 receiving the status information transmission command.

In the printer 231-M (main printer), the determining unit 295-M selects the integrated status information corresponding to a combination of the status information of the sub-printers 1 and 2 and the status information of the main printer from the integrated status information items in the customizing table 296 with reference to the customizing table 296 and converts the integrated status information to be transmitted into the selected integrated status information. For example, when a near error occurs in all of the printer 231-M (main printer) and the printers 231-1 and 231-2 (sub-printers 1 and 2), the determining unit 295-M selects the integrated status information (status information indicating that there is an error) from the customizing table 296 and transmits the integrated status information to the printing server 11. The printing server 11 acquires the status information indicating that there is an error.

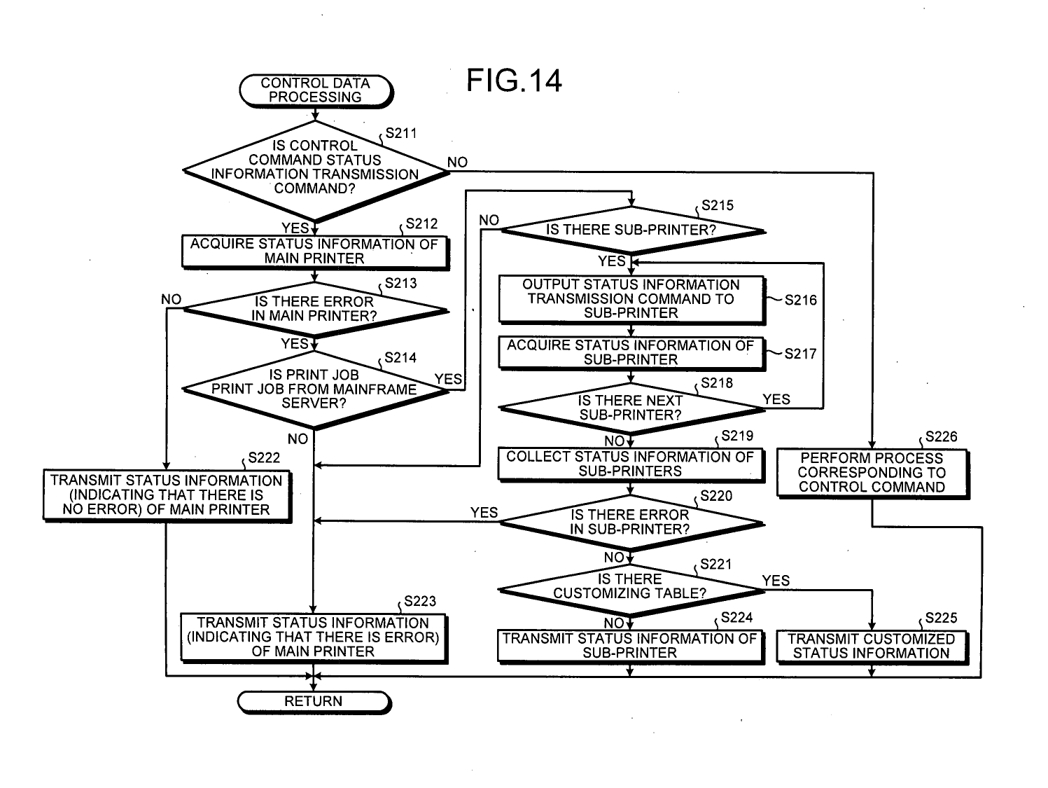

FIG. 14 is a flowchart illustrating a procedure of control data processing (see FIG. 7) according to the second embodiment. As shown in the flowchart of FIG. 14, similarly to Step S11 in FIG. 8, the data determining unit 93-M of the printer 231-M, which is the main printer, determines whether the control command included in the control data is a status information transmission command (Step S211). When the data determining unit 93-M determines that the control command is not a status information transmission command (No in Step S211), each component of the printer 231-M performs a process corresponding to the control command (Step S226). Then, the control data processing ends.

When the data determining unit 93-M determines that the control command is a status information transmission command (Yes in Step S211), the status information acquiring unit 294-M acquires the status information of the printer 31-M, similarly to Step S12 and Step S13 shown in FIG. 8 (Step S212). The determining unit 295-M determines whether an error occurs in the main printer (Step S213).

When it is determined that no error occurs in the main printer (No in Step S213), the determining unit 295-M directs the communication processing unit 92-M to transmit the status information (status information indicating that there is no error) of the main printer to the printing server 11 (Step S222). Then, the control data processing ends.

When the determining unit 295-M determines that an error occurs in the main printer (Yes in Step S213), the data determining unit 93-M determines whether the print job is a print job from the mainframe server, similarly to Step S14 shown in FIG. 8 (Step S214).

When the data determining unit 93-M determines that the print job is not a print job from the mainframe server (No in Step S214), the determining unit 295-M directs the communication processing unit 92-M to transmit the status information (status information indicating that there is an error) of the main printer to the printing server 11 in order to reduce the priority level of the continuation of printing (Step S223). Then, the control data processing ends.

On the other hand, when the data determining unit 93-M determines that the print job is a print job from the mainframe server (Yes in Step S214), the determining unit 295-M determines whether there is a sub-printer connected to the main printer via the network, similarly Step S15 shown in FIG. 8 (Step S215). When it is determined that there is no sub-printer connected to the main printer via the network (No in Step S215), the determining unit 295-M directs the communication processing unit 92-M to transmit the status information (status information indicating that there is an error) of the main printer to the printing server 11 (Step S223). Then, the control data processing ends.

On the other hand, when it is determined that there is a sub-printer connected to the main printer via the network (Yes in Step S215), the determining unit 295-M directs the communication processing unit 92-M to output a status information transmission command to the sub-printer, similarly to Step S16 and Step S17 shown in FIG. 8 (Step S216) and acquires the status information of the sub-printer (Step S217).

The determining unit 295-M determines whether there is a next sub-printer, similarly to Step S18 shown in FIG. 8 (Step S218). When the determining unit 295-M determines that there is a next sub-printer (Yes in Step S218), the process returns to Step S216, similarly to FIG. 8.

When it is determined that there is no next sub-printer (No in Step S218), the determining unit 295-M collects the acquired status information of the each sub-printer (Step S219) and determines whether an error occurs in the sub-printers (Step S220). When it is determined that an error occurs in all of the sub-printers (Yes in Step S220), the determining unit 295-M directs the communication processing unit 92-M to transmit the status information (status information indicating that there is an error) of the main printer to the printing server 11 (Step S223). Then, the control data processing ends.

On the other hand, when it is determined that no error occurs in the sub-printer (No in Step S220), the determining unit 295-M determines whether the customizing table 296 is stored in the NV-RAM 84 (Step S221). When it is determined that the customizing table 296 is not stored (No in Step S221), the determining unit 295-M transmits the status information indicating that no error occurs in the sub-printer to the printing server 11 (Step S224). Then, the control data processing ends.

On the other hand, when it is determined that the customizing table 296 is stored (Yes in Step S221), the determining unit 295-M customizes the status information for transmission content corresponding to a combination of the acquired integrated status information items of the printer 231-M and the printers 231-1 and 231-2 with reference to the customizing table 296 and transmits the customized status information as the integrated status information to the printing server 11 (Step S225). Then, the control data processing ends.

As such, in the second embodiment, the content of the status information which is customized according to a combination of the status information of the main printer and the status information of the sub-printers is set for each main printer such that printing can be continuously performed as much as possible. In this way, a printing delay is reduced and the reliability of printing is improved.

In the second embodiment, when the number of sub-printers that can replace the printer 231-M (main printer) is two or less, the determining unit 295-M of the printer 231-M may generate the status information indicating that there is an error without referring to the table T1 and direct the communication processing unit 92-M to transmit the status information to the printing server 11.

A control program executed in this embodiment is recorded as a file of an installable format or an executable format on a computer-readable recording medium, such as a CD-ROM, a flexible disk (FD), a CD-R, or a digital versatile disk (DVD) and then provided.

The control program executed in this embodiment may be stored in a computer that is connected to a network, such as the Internet, may be downloaded via the network, and may be provided. In addition, the control program executed in this embodiment may be provided or distributed via a network, such as the Internet. Of course, control program executed in this embodiment may be incorporated into a ROM in the printer in advance and then provided.

The printer is not limited to the laser printer or the MFP, but this embodiment can be applied to a digital copier, a facsimile, and any apparatus having the functions of a scanner, a copier, a facsimile, and a printer.

According to the embodiments of the invention, when the status information of the printing apparatus indicates an error, it is determined whether a printing process can be continuously performed on the basis of the status information of the printing apparatus and the status information of another printing apparatus connected to the printing apparatus via a network. The status information is transmitted to a host apparatus according to the determination result. Therefore, even when an error occurs in the connected printing apparatus, integrated status information including the status information of another printing apparatus connected to the printing apparatus via the network is transmitted as a response. Therefore, it is possible to reduce a printing delay and thus improve the reliability of printing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A printing apparatus
that performs a printing process related to a print job including one print data item or a plurality of print data items and a series of process commands transmitted from a host apparatus and
that is connected to another printing apparatus via a network,
the printing apparatus comprising:
a status information acquiring unit that acquires status information of the printing apparatus when a status information transmission command is received as the process command transmitted from the host apparatus;
a determining unit that synthetically determines whether the printing process can be continuously performed, on the basis of the status information of the printing apparatus and the status information of another printing apparatus connected to the printing apparatus via the network, when the status information of the printing apparatus acquired by the status information acquiring unit indicates an error; and
a communication processing unit that transmits integrated status information corresponding to the determination result of the determining unit to the host apparatus.

2. The printing apparatus according to claim 1,
wherein, when the status information of the printing apparatus acquired by the status information acquiring unit indicates an error, the determining unit directs the communication processing unit to output a status information transmission command to another printing apparatus.

3. The printing apparatus according to claim 2,
wherein, when status information indicating that there is no error is included in the status information transmitted from another printing apparatus, the determining unit directs the communication processing unit to transmit integrated status information indicating that printing can be continuously performed to the host apparatus.

4. The printing apparatus according to claim 2,
wherein, when the error of the status information of the printing apparatus acquired by the status information acquiring unit is a print job overlap status and the status information transmitted from another printing apparatus indicates a print job overlap state, the determining unit directs the communication processing unit to transmit integrated status information indicating that printing can be continuously performed by adjusting printing process timing to the host apparatus.

5. The printing apparatus according to claim 2,
wherein the determining unit selects an integrated status information corresponding to a combination of the status information of the printing apparatus acquired by the status information acquiring unit and the status information transmitted from another printing apparatus among the integrated status information items in a correspondence table in which the integrated status information items to be transmitted to the host apparatus according to each combination of the status information of the printing apparatus and the status information of another printing apparatus are associated in advance, and
the communication processing unit transmits the integrated status information selected by the determining unit to the host apparatus.

6. The printing apparatus according to claim 5,
wherein, a plurality of the host apparatuses are provided, and
the transmission content is set for each host apparatus in the correspondence table.

7. A printing system comprising:
a host apparatus; and
two or more printing apparatuses that perform a printing process related to a print job including one print data item or a plurality of print data items and a series of process commands transmitted from the host apparatus,
wherein the host apparatus and the two or more printing apparatuses are connected via a network, and
the printing apparatus comprises:
a status information acquiring unit that acquires status information of the printing apparatus when a status information transmission command is received as the process command transmitted from the host apparatus;
a determining unit that synthetically determines whether the printing process can be continuously performed, on the basis of the status information of the printing apparatus and the status information of another printing apparatus connected via the network, when the status information of the printing apparatus acquired by the status information acquiring unit indicates an error; and
a communication processing unit that transmits integrated status information corresponding to the determination result of the determining unit to the host apparatus.

8. A method of controlling a printing apparatus,
the printing apparatus
performing a printing process related to a print job including one print data item or a plurality of print data items and a series of process commands transmitted from a host apparatus and
connected to another printing apparatus via a network,
the method comprising:
acquiring status information of the printing apparatus when a status information transmission command is received as the process command transmitted from the host apparatus and storing the acquired status information in a storage unit;
determining whether the printing process can be continuously performed, on the basis of the status information of the printing apparatus and the status information of another printing apparatus connected to the printing apparatus via the network, when the status information of the printing apparatus acquired in the acquiring of status information indicates an error; and
transmitting the status information to the host apparatus according to the determination result in the determining.
